(19) United States
(12) Patent Application Publication
(10) Pub. No.: US 2005/0117594 A1
(43) Pub. Date: Jun. 2, 2005

(54) Modem pass-through panacea for voice gateways

(75) Inventor: Patrick D. Ryan, Yorba Linda, CA (US)

Correspondence Address: FARJAMI & FARJAMI LLP, 26522 LA ALAMEDA AVENUE, SUITE 360, MISSION VIEJO, CA, 92691, US

(73) Assignee: Mindspeed Technologies, Inc.

(21) Appl. No.: 10/726,200

(22) Filed: Dec. 1, 2003

(51) Int. Cl. H04L 12/56

(52) U.S. Cl. 370/401

(57) ABSTRACT

A first gateway is provided for establishing a communicating path for a user placing a call on a communication line. The first gateway has a plurality of modes of operation, including a data mode and a voice mode, wherein the first gateway is configured differently for each of the modes of operation. In one aspect, a communication method comprises the steps of configuring the first gateway to the data mode of operation; receiving a call from the user over the communication line; enabling the first gateway to detect human voice and/or silence on the communication line; maintaining the first gateway configured according to the configuring step in the data mode of operation if the first gateway does not detect human voice or silence on the communication line; and reconfiguring the first gateway to the voice mode if the first gateway detects human voice or silence on the communication line.

### BACKGROUND OF THE INVENTION

1. Field of the Invention

The present invention generally relates to communications over packet networks, such as Internet Protocol (“IP”) and, more particularly, to connecting communication devices over IP, such as connecting modem devices over IP.

2. Related Art

Today the traditional analog telephony is being rapidly replaced with digital IP telephony, which use various techniques to break voice into data packets for transmission over packet networks. Analog modems have been utilized to provide data, facsimile and voice communications over twisted pair telephone lines for decades. Modem is an analog-to-digital and digital-to-analog converter, which is capable of adapting a terminal or computer to an analog telephone line by converting digital pulses to audio frequencies and vice versa. Because a significant infrastructure is in place using such modems, the packet networks need to address and support modem communication.

FIG. 1 illustrates a block diagram of a conventional communications network 100 utilizing modems for communication over a packet network protocol, such as Internet Protocol, which may also be referred to as Modem over Internet Protocol (“MoIP”). As shown, communications network 100 includes first communication device 102 in communication with first gateway device 104 and second gateway device 114 in communication with second communication device 122. Communications network 100 further includes a packet network protocol, such as IP 112 to provide communications between first gateway device 104 and second gateway device 114. IP 112 implements the network layer (layer 3) of a network protocol, which contains a network address and is used to route a message to a different network or subnetwork. IP 112 accepts packets from the layer 4 transport protocol, such as Transmission Control Protocol (“TCP”) or User Data Protocol (“UDP”), and adds its own header and delivers the data to the layer 2 data link protocol. TCP provides transport functions, which ensures that the total amount of bytes sent is received correctly at the other end. UDP, which is part of the TCP/IP suite, is an alternate transport that does not guarantee delivery. UDP is widely used for real-time voice and video transmissions where erroneous packets are not retransmitted.

Devices 102, 104, 114 and 122 may include modems (modulator-demodulator). Modems may support a variety of data modulation standards, such as ITU (International Telecommunications Union) standards: V.22bis, V.34, V.90 or V.92, etc. Typically, modems have built-in error correction, such as MNP2-4 or LAPM (or V.42) and data compression, such as MNP5, V.42bis or V.44. Modems are also capable of supporting various voice and facsimile standards.

The communication process begins when first communication device 102, e.g. first modem (“M1”), originates a call to establish communications with second communication device 122, e.g. second modem (“M2”). First gateway device 104 (“G1”) receives the call and informs second gateway device 114 (“G2”) of the call for M2 over communications network 100 and, as a result, G2 calls M2.

Typically, in the default mode of operation, G1 and G2 communicate in voice mode and use compressed voice protocol, such as the ITU standard G.723.1. Conventionally, after M2 receives the call from G2, M2 answers the call and starts sending certain defined initiating signals, such as an answer tone, which is typically transmitted at about 2100 Hz frequency. At this point, G2 starts confirming the answer tone for a pre-defined period of time, e.g. 50 ms to 1000 ms. Once G2 confirms the answer tone, G2 informs G1 that the present communication session is a modem or facsimile session.

However, once G2 detects the answer tone, e.g., 2100 Hz tone, from M2, then G2 and G1 switch to an uncompressed voice protocol, such as an ITU standard G.711, which provides toll quality audio at 64 Kbps using either A-Law or mu-Law pulse code modulation methods. This uncompressed digital format is used in order to allow easy connections to legacy telephone networks. By switching to G.711, the signals generated by M2 may propagate through from G2 to G1 in a more intact manner in order to reach the first modem at the other side, which is known as modem pass-through mode of MoIP.

The above-described modem pass-through approach, however, has many drawbacks and disadvantages. For example, because there are many different types of data terminals (i.e. modem terminals, facsimile terminals, etc.) that must be detected by the gateways, not only accommodating the detection of many types of data terminals increases the complexity of a gateway device, but also there may always be certain data terminals that are not foreseen and cannot be detected by the gateway device. For instance, not all modems may transmit an answer tone upon answering the call, and some modems that do transmit an answer tone may not transmit the answer tone at 2100 Hz. Further, certain proprietary point-of-sale (POS) modems, such as VeriFone or Hypercom POS terminals may implement proprietary training methods that transmit other signals upon answering the call. Also, some proprietary training methods may shorten the answer tone duration to reduce the training time, such that the gateway device may not be able to properly detect the answer tone. Therefore, there are many instances in which the gateway device may not detect the data terminal properly and, as a result, the gateway device does not configure itself to accommodate the data terminal by, for example, switching from a low quality voice coder to a high bandwidth voice coder, such as G.711, freezing the jitter buffer, adjusting the jitter buffer size, etc. The U.S. patent application Ser. No. 09/553,773, filed Apr. 21, 2000, entitled “Methods and Apparatus for Data Communication on Packet Networks” describes gateway configuration for accommodating modem communication over the packet network, which is hereby incorporated by reference in its entirety. In the event that the gateway device fails to configure itself to accommodate end-to-end modem training, the modem training may fail or the modems may connect at lower speeds due to undesirable line conditions caused by a low bandwidth coder, such as G.723.1 coder. Further, even if a modem connection is established utilizing a low bandwidth coder, delays and data loss may be experienced.

Another problematic area that has been extremely challenging with the conventional approach is finding a solution to accommodate or connect TTY (Text Telephone) modems over a packet network. TTY modems are also sometimes referred to as a TDD (Telecommunication Device for the Deaf) modems, which are special devices that allow deaf, hard of hearing, or speech-impaired people to use the telephone to communicate. Telephone communication for such users is accomplished by allowing them to type messages back and forth to one another instead of talking and listening. A TTY modem is required at both ends of the conversation in order to establish a telephone communication. However, TTY modems do not use the same communication protocol as regular data modems and, thus, TTY modems require the gateways to perform a different detection algorithm for detecting TTY modems in order to configure the gateways properly. Even worse, there are several different TTY modems, such as Baudot @ 45.45 baud (U.S. TTYs); Baudot @ 50 baud (international Baudot used in Australia, England, and other countries); V.21/text telephone version (Sweden, Norway, and Finland); DTMF (Denmark, Holland, other countries); and EDT (“European Deaf Telephone”, Germany, Austria, Switzerland, and other countries, which are the focus of a unifying standard called ITU V.18.

Therefore, the conventional approach for supporting modems over packet networks requires development and testing of numerous modem detection algorithms to detect various data modem protocols, facsimile modem protocols, TTY modem protocols, etc. Even yet, the gateway devices may not be able to properly detect all modems because of proprietary protocols used by some modem manufacturers. Further, the development and testing of the algorithms to detect numerous modems are quite time consuming, let alone the sustaining efforts, the memory space consumed by the algorithms, possibility of a false detection that can result in call termination or low speed connection, the added execution time, and so on.

Accordingly, there is an intense need for an efficient cure-all approach or a panacea to modem pass-through for connections over packet networks, where all types of modems can be accommodated, and any possibility of call termination or low speed connections due to improper gateway configuration can be avoided.

### SUMMARY OF THE INVENTION

In accordance with the purpose of the present invention as broadly described herein, there are provided methods, systems and devices for use by a first gateway to provide a communicating path to a user placing a call on a communication line and through a packet network to a second gateway. The first gateway has a plurality of modes of operation including a data mode and a voice mode, wherein the first gateway is configured differently for each of the modes of operation. In one aspect, a communication method for use by the first gateway comprises the steps of configuring the first gateway to the data mode of operation; receiving a call from the user over the communication line; enabling the first gateway to detect human voice and/or silence on the communication line; maintaining the first gateway configured according to the configuring step in the data mode of operation if the first gateway does not detect human voice or silence on the communication line; and reconfiguring the first gateway to the voice mode if the first gateway detects human voice or silence on the communication line.

In a further aspect, the method further comprises the step of informing the second gateway over the packet network of the mode of operation of the first gateway after the steps of maintaining and reconfiguring. Also, in one aspect, the step of maintaining occurs if the first gateway does not detect human voice or silence on the communication line for a predetermined period of time. In another aspect, the method further comprises the step of informing the second gateway over the packet network of the mode of operation of the first gateway if the first gateway detects human voice or silence on the communication.

In one aspect, the data mode is a modem mode and the user is a modem device, a fax device, or a TTY modem. Further, in the data mode the first gateway uses a voice coder with higher bandwidth than in the voice mode. For example, in the data mode the first gateway uses a G.711 voice coder and in the voice mode the first gateway uses a G.723.1 voice coder.

In yet another aspect, the first gateway has a jitter buffer, wherein the jitter buffer is larger in the voice mode than in the data mode. Also, the jitter buffer is frozen in the data mode and is dynamic in the voice mode.

According to other aspects, systems, devices and computer software products or media for use by the first gateway in accordance with the above techniques are provided.

These and other aspects of the present invention will become apparent with further reference to the drawings and specification, which follow. It is intended that all such additional systems, methods, features and advantages be included within this description, be within the scope of the present invention, and be protected by the accompanying claims.

### BRIEF DESCRIPTION OF DRAWINGS

The features and advantages of the present invention will become more readily apparent to those ordinarily skilled in the art after reviewing the following detailed description and accompanying drawings, wherein:

FIG. 1 illustrates a block diagram of a conventional communications network utilizing modems for communication over a packet network protocol;

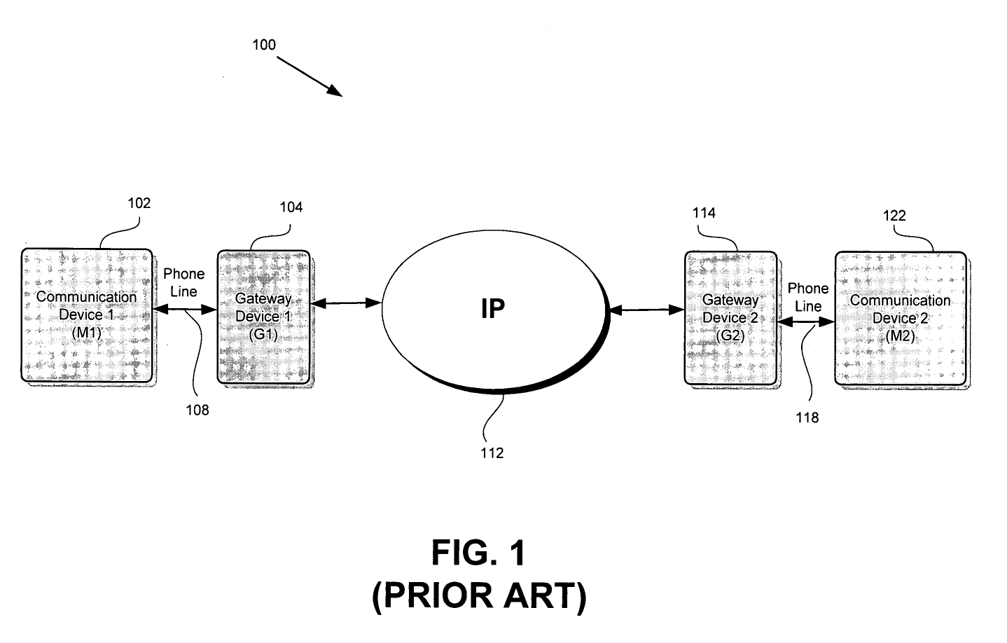

FIG. 2 illustrates a block diagram of a gateway device according to one embodiment of the present invention; and

FIG. 3. Illustrates a flow diagram of an algorithm for implementation by the gateway device of FIG. 2.

### DESCRIPTION OF EXEMPLARY EMBODIMENTS

The present invention may be described herein in terms of functional block components and various processing steps. It should be appreciated that such functional blocks may be realized by any number of hardware components and/or software components configured to perform the specified functions. For example, the present invention may employ various integrated circuit components, e.g., memory elements, digital signal processing elements, logic elements, and the like, which may carry out a variety of functions under the control of one or more microprocessors or other control devices. Further, it should be noted that the present invention may employ any number of conventional techniques for data transmission, signaling, signal processing and conditioning, tone generation and detection and the like. Such general techniques that may be known to those skilled in the art are not described in detail herein.

It should be appreciated that the particular implementations shown and described herein are merely exemplary and are not intended to limit the scope of the present invention in any way. For example, although the present invention is described using a modem over IP network, it should be noted that the present invention may be implemented in other communications networks and is not limited to modem over IP.

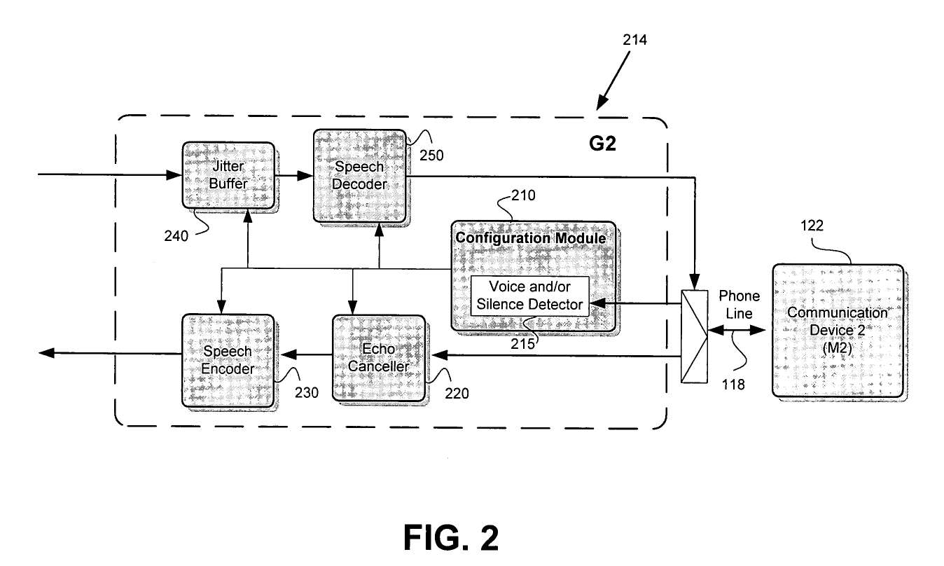

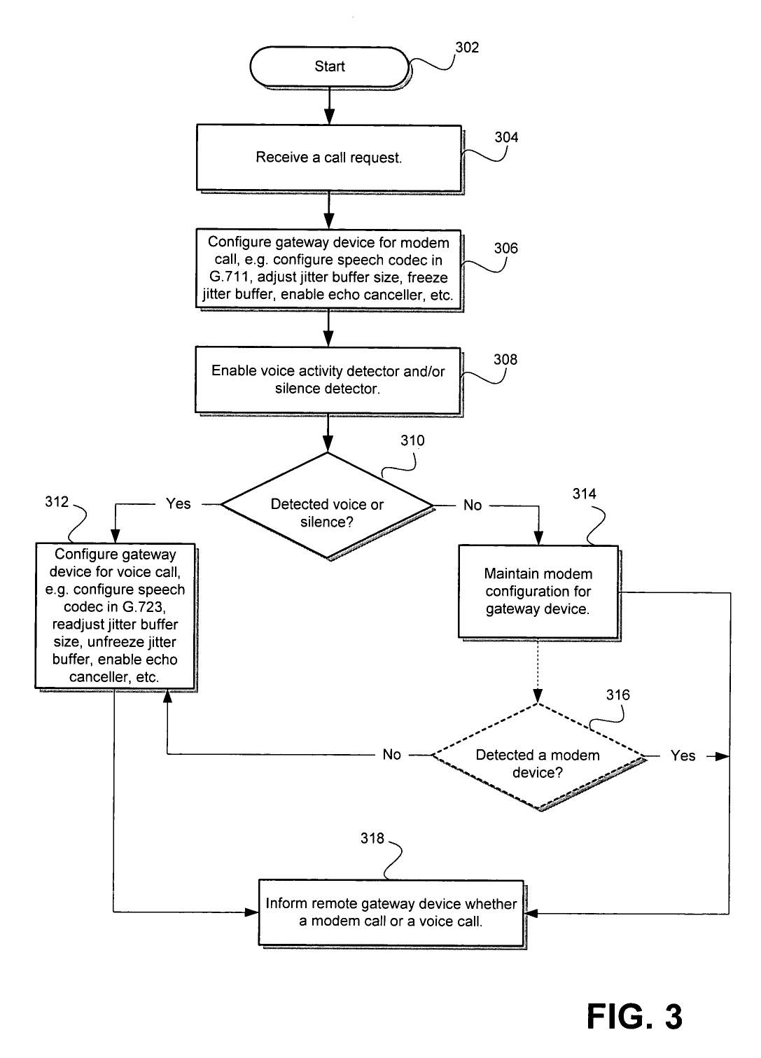

FIG. 2 illustrates a block diagram of gateway device (G2) 214 according to one embodiment of the present invention. G2 214 has the same location as G2 114 in communications network 100. In one embodiment, a process begins at step 302 of FIG. 3, and at step 304, G2 214 receives a call request over a packet network, e.g. IP 112, from G1 104. As explained above, the call process initiated when a user, such as a human, modem device, fax device, TTY device, etc. places a call to G1 104, which in turn transmits a call request to G2 214. Prior to or upon receiving the call request, at step 306, configuration module 210 configures various components of G2 214 for a data mode based on the assumption that the call is a data call, such as a modem call or a fax call. Accordingly, configuration module 210 configures speech encoder 230 and speech decoder 250 to use a high quality voice coder, such as G.711, which utilizes 64 kbps of bandwidth, to ensure that modem signals from M2 122 can reach G1 104 in substantially intact manner. In some embodiments, other high quality voice coders may be used, and also speech encoder 230 and speech decoder 250 may be part of a single codec. Configuration module 210 may be any microprocessor or controller, and the codec may support various speech coding standards, such as G.726, G.729, G.723.1, G.711, etc.

Further, at step 306, configuration module 210 may adjust the size of jitter buffer 240 and may also freeze jitter buffer 240, so its size does not vary dynamically. For example, configuration module 210 may set the size of jitter buffer 240 to be smaller than a typical jitter buffer size for a voice call. In addition, at step 306, configuration module 210 enables echo canceller 220. In one embodiment, configuration module 210 may configure various components of G2, as described in the U.S. patent application Ser. No. 09/553,773, filed Apr. 21, 2000, entitled “Methods and Apparatus for Data Communication on Packet Networks”, which describes gateway configuration for accommodating modem communication over the packet network.

Next, at step 308, configuration module 210 enables voice and/or silence detector 215 to monitor signals on communication line or phone line 118, which are generated by the user of phone line 118, such as M2 122, a fax device, a TTY device, a human, etc. In one embodiment, voice and/or silence detector 215 may also detect music. It should be noted that voice activity detectors (VADs), and silence and music detectors are well known to those of ordinary skill in the art. At step 310, if voice and/or silence detector 215 does not detect human voice or silence, for a predetermine period of time, such as five seconds, the process moves to step 314, where G2 214 maintains the default configuration, as described above. However, if voice and/or silence detector 215 detects human voice or silence, the process moves to step 312, where configuration module 210 reconfigures G2 214 in a voice mode for processing a voice call. The voice call configuration may include configuring speech encoder 230 and speech decoder 250 for a lower bandwidth voice coder, such as G.723.1, which utilizes 5.3 or 6.4 kbps of bandwidth. Further, configuration module 210 may increase the size of jitter buffer 240 for supporting the voice call and may provide for dynamic jitter buffer.

In one embodiment, the process may move from step 314 to step 316, where for some time, G2 214 monitors phone line 118 to determine whether a modem signal is received, e.g. from M2 122. For example, as in the conventional approach, G2 214 may monitor phone line 118 for a modem answer tone. If a modem signal is detected at step 316, the process moves to step 312.

At step 318, once G2 214 determines the call type, G2 214 informs G1 104 over the packet network regarding the same, and G1 104 will be able to configure its speech encoder, speech decoder, jitter buffer, echo canceller, etc. accordingly. For example, if voice and/or silence detector 215 does not detect human voice or silence, G2 214 may inform G1 104 to configure itself for a modem call. In one embodiment, if voice and/or silence detector 215 does not detect human voice or silence, G2 214 may not transmit any information to G1 104, and G1 104 may remain in its default configuration, as described in step 306 above, which is to support a modem call. However, if voice and/or silence detector 215 detects human voice or silence, G2 214 informs G1 104 that the current call is a voice call, such that G1 104 can configure itself similar to step 312 above for supporting the voice call.

One of the advantages of the present invention is that even if human voice or silence on phone line 118 is not properly detected, the voice call will not be lost or terminated, but to the contrary, a higher quality voice communication is provided to the users. This is in sharp contrast to the conventional approach, where the gateway device is configured to support voice calls and to detect modem signals, and if the modem signals are not properly detected, a low quality voice coder, such as G.723.1 is utilized, which will cause modem call termination and/or significant reduction in modem speed.

Referring back to FIG. 3, the process of FIG. 3 equally applies to fax calls, where G2 214 receives a call from a fax device on phone line 118. In that event, fax signals, such as a fax calling tone, will cause the process to move to steps 314, 316 and 318, where G2 214 informs G1 104 of the fax call. As stated above, after step 314, steps 316 and 318 are optional steps and may not exist in some embodiments.

The methods and systems presented above may reside in software, hardware, or firmware on the device, which can be implemented on a microprocessor, digital signal processor, application specific IC, or field programmable gate array (“FPGA”), or any combination thereof, without departing from the spirit of the invention. Furthermore, the present invention may be embodied in other specific forms without departing from its spirit or essential characteristics. The described embodiments are to be considered in all respects only as illustrative and not restrictive.

1. A communication method for use by a first gateway to communicate with a second gateway over a packet network, said first gateway capable of providing a communicating path to a user placing a call on a communication line, said first gateway having a plurality of modes of operation including a data mode and a voice mode, wherein said first gateway is configured differently for each of said modes of operation, said method comprising the steps of:
configuring said first gateway to said data mode of operation;
receiving a call from said user over said communication line;
enabling said first gateway to detect human voice and/or silence on said communication line;
maintaining said first gateway configured according to said configuring step in said data mode of operation if said first gateway does not detect human voice or silence on said communication line; and
reconfiguring said first gateway to said voice mode if said first gateway detects human voice or silence on said communication line.

2. The method of claim 1 further comprising the step of: informing said second gateway over said packet network of said mode of operation of said first gateway after said steps of maintaining and reconfiguring.

3. The method of claim 1, wherein said step of maintaining occurs if said first gateway does not detect human voice or silence on said communication line for a predetermined period of time.

4. The method of claim 1, wherein said data mode is a modem mode and said user is a modem device.

5. The method of claim 1, wherein said data mode is a modem mode and said user is a fax device.

6. The method of claim 1, wherein said data mode is a modem mode and said user is a TTY modem.

7. The method of claim 1, wherein in said data mode said first gateway uses a voice coder with higher bandwidth than in said voice mode.

8. The method of claim 7, wherein in said data mode said first gateway uses a G.711 voice coder and in said voice mode said first gateway uses a G.723.1 voice coder.

9. The method of claim 1, wherein said first gateway has a jitter buffer, and wherein said jitter buffer is larger in said voice mode than in said data mode.

10. The method of claim 1, wherein said first gateway has a jitter buffer, and wherein said jitter buffer is frozen in said data mode and is dynamic in said voice mode.

11. The method of claim 1 further comprising the step of: informing said second gateway over said packet network of said mode of operation of said first gateway if said first gateway detects human voice or silence on said communication.

12. A first gateway for communication with a second gateway over a packet network, said first gateway capable of providing a communicating path to a user placing a call on a communication line, said first gateway having a plurality of modes of operation including a data mode and a voice mode, wherein said first gateway is configured differently for each of said modes of operation, said first gateway comprising:
a configuration module configuring said first gateway to said data mode of operation;
a voice and/or silence detector enabled to detect human voice or silence on said communication line when said user places call on said communication line to said first gateway;
wherein said configuration module maintains said first gateway configured according to said data mode of operation if said voice and/or silence detector does not detect human voice or silence on said communication line, and said configuration module reconfigures said first gateway to said voice mode if said voice and/or silence detector detects human voice or silence on said communication line.

13. The first gateway of claim 12, wherein said first gateway informs said second gateway over said packet network of said mode of operation of said first gateway after said configuration module maintains said data mode configuration or reconfigures to said voice mode.

14. The first gateway of claim 12, wherein said configuration module maintains said data mode configuration if said voice and/or silence detector does not detect human voice or silence on said communication line for a predetermined period of time.

15. The first gateway of claim 12, wherein said data mode is a modem mode and said user is a modem device.

16. The first gateway of claim 12, wherein said data mode is a modem mode and said user is a fax device.

17. The first gateway of claim 12, wherein said data mode is a modem mode and said user is a TTY modem.

18. The first gateway of claim 12, wherein in said data mode said first gateway uses a voice coder with higher bandwidth than in said voice mode.

19. The first gateway of claim 18, wherein in said data mode said first gateway uses a G.711 voice coder and in said voice mode said first gateway uses a G.723.1 voice coder.

20. The first gateway of claim 12, wherein said first gateway has a jitter buffer, and wherein said jitter buffer is larger in said voice mode than in said data mode.

21. The first gateway of claim 12, wherein said first gateway has a jitter buffer, and wherein said jitter buffer is frozen in said data mode and is dynamic in said voice mode.

22. The first gateway of claim 12, wherein first gateway informs said second gateway over said packet network of said mode of operation of said first gateway if said first gateway detects human voice of silence on said communication.
